(19) United States
(12) Patent Application Publication
(10) Pub. No.: US 2022/0351636 A1
(43) Pub. Date: Nov. 3, 2022

(54) SYSTEMS AND METHODS FOR DYNAMIC, ACTIVE, G-FORCE AND FLIGHT SIMULATOR

(71) Applicant: Vi-gation Ltd, Moshav Ben Shemen (IL)

(72) Inventors: Uri RAPOPORT, Moshav Ben Shemen (IL); Jacob STERN, Shoham (IL)

(73) Assignee: Vi-gation Ltd, Moshav Ben Shemen (IL)

(21) Appl. No.: 17/868,861

(22) Filed: Jul. 20, 2022

Related U.S. Application Data
(63) Continuation of application No. PCT/IL2021/050068, filed on Jan. 21, 2021.
(60) Provisional application No. 62/964,459, filed on Jan. 22, 2020.
(60) Provisional application No. 63/047,079, filed on Jul. 1, 2020.
(60) Provisional application No. 63/055,983, filed on Jul. 24, 2020.
(60) Provisional application No. 63/067,174, filed on Aug. 18, 2020.
(60) Provisional application No. 63/073,793, filed on Sep. 2, 2020.

(51) Int. Cl. G09B 9/12

(52) U.S. Cl. CPC G09B 9/12

(57) ABSTRACT

Systems and methods for flight simulation are provided. In particular, systems and methods that can allow for G-force simulation on a body of a pilot while moving the pilot and providing a realistic flight simulation display to a pilot are provided. The systems and methods can include a seating area that includes a plurality of force exertion components coupled to the chair that can apply force vectors to body parts of the pilot, a motorized frame to rotate the seating area along a pitch, yaw, and/or roll axis, a canopy coupled to the seating area to view simulation such that a pilot can experience a realistic flight simulation.

### CROSS REFERENCE TO RELATED APPLICATIONS

This application claims the benefit of and priority to U.S. Provisional Patent Application No. 62/964,459, filed Jan. 22, 2020, U.S. Provisional Patent Application No. 63/047,079, filed Jul. 1, 2020, U.S. Provisional Patent Application No. 63/055,983 filed Jul. 24, 2020, U.S. Provisional Patent Application No. 63/067,174 filed Aug. 18, 2020, and U.S. Provisional Patent Application No. 63/073,793 filed Sep. 2, 2020, all incorporated herein by reference in their entireties, and owned by the assignee of the instant application.

### FIELD OF THE INVENTION

The invention relates generally to flight simulators for pilots. In particular, flight simulators that simulate g-forces typically experienced by a pilot during flight along with a realistic visual experience.

### BACKGROUND OF THE INVENTION

Safe flying of aircrafts can heavily depend on the skill level of the pilot. Typically, pilots train many hours to fly aircraft safely. Training can involve using flight simulators to simulate flying conditions for the pilot. When flying an aircraft (e.g., an F-16) pilots can experience effects of g-force. In some scenarios, pilots can experience a g-force that significantly physically effects the pilot. For example, when a g-force of ˜2.5-3 g is applied to a pilot, blood can be pulled down from the head of the pilot towards the legs. This can cause difficulty seeing, loss of consciousness and/or swelling of legs. Additionally, the ability for a pilot to breath in can be hampered once a complete exhale is done by the pilot while experiencing g-force.

As g-force is progressively increased (e.g., positive g's) the pilot can experience a grey-out (e.g., where the pilot's vision loses hue which can be easily reversible on levelling out); tunnel vision (e.g., where peripheral vision is progressively lost); blackout (e.g., a loss of vision while consciousness is maintained); g-LOC (e.g., a g-force induced loss of consciousness); and death.

For example, if a pilot is exposed to 6-9 g for more than 20 seconds, the pilot can faint. If a pilot is exposed to 6-9 g for 2-3 minutes, the pilot can die.

Negative g-force (e.g., downward) can drive blood to the pilot's head, and typically pilots have less physical tolerances for negative g-force (e.g., −2 to −3 range). Negative g is generally unpleasant and can cause permanent damage to a pilot. Blood vessels in the eyes or brain may swell and/or burst under increased blood pressure that can be caused by negative g, resulting in degraded sight or even blindness.

In some scenarios, g-force can make a pilot feel like they are heavier than what they actually weigh.

Currently, pilots can use a G-suit to minimize the effect of blood related events of the g-force during flight. Other methods to reducing an effective vector on the body due to the g-force can include tilting a pilot's seat to assist in reducing the g-force are used. When engaged in air warfare, pilots can perform maneuvers and/or speeds that can cause significant g-force, despite the measures that have been taken to reduce the impacts of g-force.

Each pilot can respond to the g-force differently. One pilot may be able to withstand a higher g-force then another pilot and/or the g-force for a slightly longer duration than another pilot. Flight simulation systems exist that simulate the g-force, such that a pilot can learn their tolerance for exposure to the g-force prior to experiencing the g-force during actual flight.

Centrifuge flight simulators are large centrifuge devices that can produce high acceleration and thus high g-forces by rapid rotation. A centrifuge device can apply an acceleration and/or rotation to a pilot's body similar to that as if they were in flight. Centrifuge flight simulators can be very expensive, hard to build and/or can require a lot of space to implement. Therefore, it can be desirable to subject pilots to g-force prior to flight while reducing cost of such systems.

Current flight simulators typically show a pilot a scene of moving around via windows in the simulation. For example, if the pilot is turning the aircraft during flight simulation, the windows and/or VR goggles can display an image that show the earth moving around the pilot. However, in real life, the pilot's body moves during turning. Movement during turning can cause fluids withing the ears of a pilot to move around and can in some scenarios cause a loss of balance. Therefore, it can be desirable to simulate flight in a manner that causes physical effects on a pilot during simulation similar to the physical effects that can occur during actual flight.

It can be desirable to physically move the pilot in-order to get maximum (or near maximum) physical/biological effect on the pilot body, head, inner ears, and/or mind. Such a system can require a change to the prior displays of flight simulators, which are typically programmed for a flight simulation where the pilot is physically stationary.

### SUMMARY OF THE INVENTION

One advantage of the invention can be an ability to simulate g-force on a pilot that can change as a function of the simulation, commanded flight inputs of a user (e.g., pilot or gamer), movement of a chair of that the user is positioned within and/or movement of the user. Another advantage of the invention can be the ability to modify the g-force applied to the user in real-time (e.g., within a time frame that is similar to how g-force changes during flight maneuvers). Another advantage of the invention can be the ability to simulate g-force without a centrifuge.

Another advantage of the invention can be the ability to simulate a g-force with a varying intensity, such that for example, a new cadet, experienced cadet, gamer, or casual user can experience a g-force that is desired for the experience they seek.

Another advantage of the invention can be the ability to simulate g-force without and entire simulator. Another advantage of the invention can be the ability to view a simulation in a 4 pi (4π) steradians view that can provide an realistic experience for training pilots for flight and/or battle conditions.

Another advantage of the invention can be the ability to simulate a malfunction of the pilot chamber pressurization system by for example, reducing pressure the pilot's ear are exposed to. Another advantage of the invention can be to provide artificial pain/inconvenience to teach the user to anticipate inconvenience and check how stressed is the user to reduce the inconvenience. Another advantage of the invention can be simulation of ejection forces and durations.

In one aspect, the invention includes a system for simulating flight and corresponding G-force for a pilot. The system can include a seating area including a plurality of force exertion components coupled to the seating area to apply a plurality of force vectors to a plurality of body parts of the pilot. The system can also include a motorized frame coupled to the seating area to rotate the seating area along a pitch axis, yaw axis, roll axis, or any combination thereof. The system can also include a canopy coupled to the seating area to rotate over the seating area, the canopy having an interior surface that includes an OLED display device to display a simulation of a flight. The system can also include a processor in communication with OLED display device, the motorized frame and the plurality of force exertion components to control i) the plurality of force exertion components to apply the plurality of force vectors to the plurality of body parts, wherein an amplitude, direction and duration of the plurality of force vectors applied to the body parts are based on an amount of G-force to simulate on the body of the pilot, ii) the motorized frame to rotate the seating area based on input from the pilot and the simulation of the flight, and iii) the OLED display device output based on input from the pilot and the simulation of the flight.

In some embodiments, the plurality of force exertion component includes a jacket, two belts that span along a longitudinal axis of the jacket coupled to at least one tensing unit, and a third belt that is positioned perpendicular to the two belts and is coupled to the at least one tensing unit, wherein the at least one tensing unit tightens and loosens the two belts and the third belt to cause at least one of the plurality of force vectors.

In some embodiments, the plurality of force exertion component includes a jacket, two belts that span along a longitudinal axis of the jacket coupled to a respective tensing unit, and a third belt that is positioned perpendicular to the two belts and is coupled to a respective tensing unit, wherein each respective tensing unit and loosens the two belts and the third belt to cause at least one of the plurality of force vectors.

In some embodiments, the plurality of force exertion components includes a harness. The harness can include a first belt portion that is coupled to a bottom portion of the seating area extends along a longitudinal axis of the seating area and is coupled to a top end of a back portion of the seating area and a second belt portion that extends along the longitudinal axis of the seating area from the first belt portion to an aperture in a bottom end of the back portion and is coupled to a motor through the aperture such that the motor can tighten and loosen the second belt portion to cause at least one of the plurality of force vectors along the longitudinal axis.

In some embodiments, the system includes an artery clamping mechanism for applying a second force vector to an artery of the pilot to restrict blood flow into the head of the pilot to further simulate G-force on the body of the pilot.

In some embodiments, the artery clamping mechanism is a c-shaped structure. In some embodiments the artery clamping mechanism is a neck brace that includes one or more pads that inflate or deflate. In some embodiments, the artery claiming mechanism is a neck brace that includes a controlled spring mechanism. In some embodiments, the system includes one or more sensors to detect an eye location of the pilot's eye. In some embodiments, the system includes one or more sensors to detect a looking direction of the pilot.

In some embodiments, the plurality of force exertion components are belts and each belt is coupled to a pneumatic piston, a hydraulic piston, a pneumatic motor, a hydraulic motor or an electric rotating motor. In some embodiments, the seating area is housed within a structure that appear similar to a cockpit of a aircraft of the simulation. In some embodiments, the plurality of force exertion components are positioned to apply force on legs, shoulders, wrists, head, chest, neck or any combination thereof of the pilot. In some embodiments, the plurality of force exertion components apply a force to the pilot dependent upon an acceleration of the airplane in the simulation and a mass of the pilot. In some embodiments, the plurality of force exertion components apply a force to the pilot dependent upon an input of the pilot.

### BRIEF DESCRIPTION OF THE DRAWINGS

Non-limiting examples of embodiments of the disclosure are described below with reference to figures attached hereto that are listed following this paragraph. Dimensions of features shown in the figures are chosen for convenience and clarity of presentation and are not necessarily shown to scale.

The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanied drawings.

Embodiments of the invention are illustrated by way of example and not limitation in the figures of the accompanying drawings, in which like reference numerals indicate corresponding, analogous or similar elements, and in which:

FIG. 1A is a diagram of a flight simulator system, according to some embodiments of the invention;

FIG. 1B is a diagram of an image displayed to a pilot during a downward maneuver, according to some embodiments of the invention;

FIGS. 2A-2E are diagrams of a chair and a motion structure, according to illustrative embodiments of the invention;

FIGS. 2F-2L show the structure of FIG. 2A with a canopy and a pilot, according to various embodiments of the invention;

FIG. 3 is a diagram showing a chair, a motion structure, and a canopy, according to an illustrative embodiment of the invention;

FIGS. 4A-4C are diagrams of a flight simulator, according to illustrative embodiments of the invention;

FIGS. 5A and 5B are diagrams of a chair, a motion structure and a canopy, according to some embodiments of the invention;

FIGS. 6A and 6B are diagrams of a chair with a force exertion component, according to some embodiments of the invention;

FIGS. 6C and 6D are diagrams of the chair and the force exertion component in two different configurations, straight and crisscross, on the pilot, according to some embodiments of the invention;

FIGS. 6E and 6F are diagrams of tensing units, according to some embodiments of the invention;

FIG. 7 is an example of a force exertion component of a vest coupled to a belt, according to some embodiments of the invention.

FIGS. 8A and 8B are an example of a force exertion component of a jacket 810 coupled to a belt 820, according to some embodiments of the invention.

FIGS. 8C and 8D are an example of a force exertion component of a vest having multiple belts that connect to an airplane and multiple belts that are coupled to a respective belt tensing unit, according to embodiments of the invention.

FIGS. 8E and 8F are an example of force exertion component of multiple belts 865 that connect to an airplane and multiple belts that are coupled to a respective belt tensing unit (e.g., belt tensing unit, according to embodiments of the invention.

FIGS. 9A and 9B are an example of a plurality of force exertion components and a seat 910, according to some embodiments of the invention.

FIG. 10 shows an example of a plurality of force exertion components, according to some embodiments of the invention.

FIGS. 11A and 11B show a force exertion component of an artery claiming mechanism, according to some embodiments of the invention.

FIGS. 12A and 12B are diagrams showing an artery claiming mechanism coupled to a helmet 1220, according to some embodiments of the invention.

FIG. 13 shows a block diagram of a computing device which can be used with embodiments of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the invention can be practiced without these specific details. In other instances, well-known methods, procedures, and components, modules, units and/or circuits have not been described in detail so as not to obscure the invention.

Generally, the invention includes a flight simulator system that can simulate flight for a user (e.g., a pilot) that can involve imposing a physical sensation of flight on the pilot and/or a visual presentation of the flight to the pilot. The physical sensation of flight can include moving a pilot via a motion structure and/or imposing forces onto the pilot that feel to the pilot like similar motions that occur during flight including imposing sensations that are similar to g-forces. The visual presentation of the flight to the pilot can include presenting a visual display output that can be y responsive to input from the pilot and/or responsive to location of the pilot in the simulator as the pilot is moved about by the motion structure. The flight simulator system can include a seating area (e.g., a chair or a cockpit), a motion structure, a display device, one or more force exertion components, a controller (e.g., a joystick) and/or a processor.

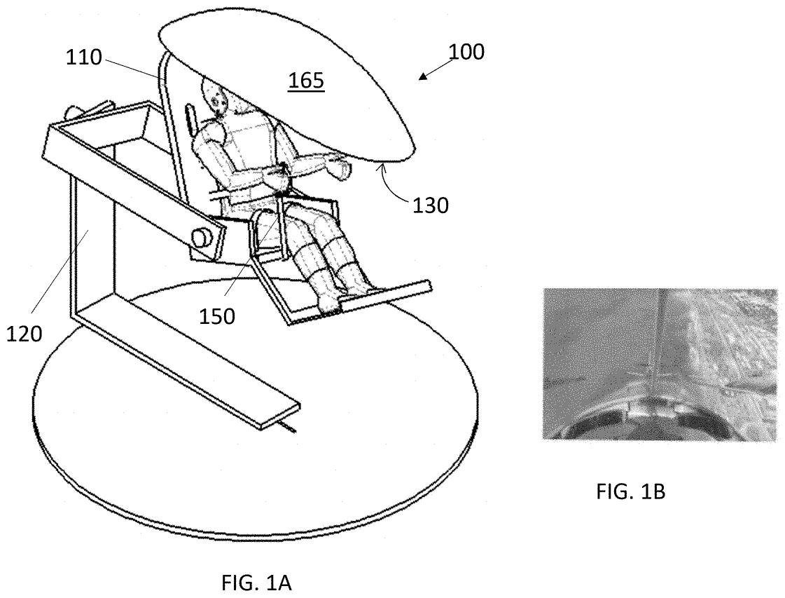

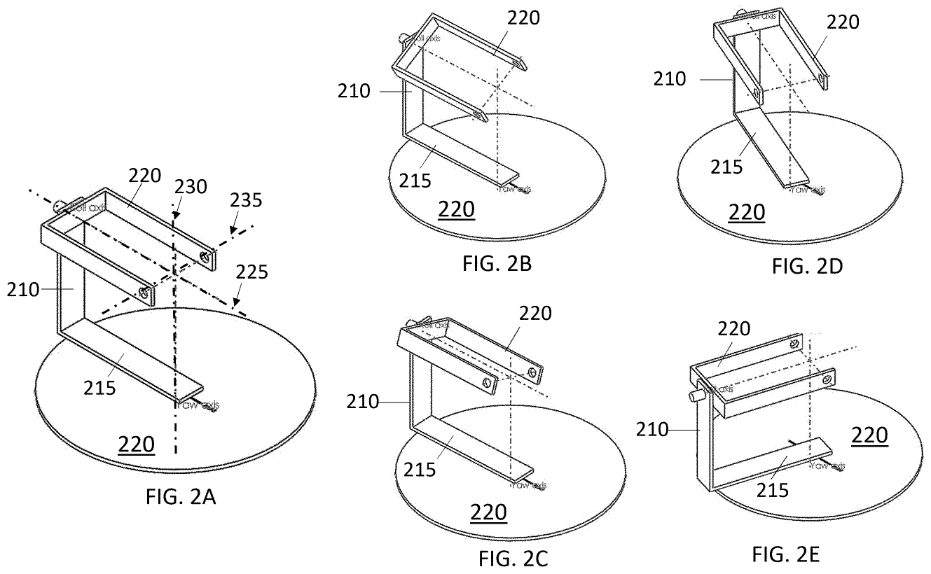

FIG. 1A is a diagram of a flight simulator system 100, according to some embodiments of the invention. The flight simulator system 100 includes a chair 110, a motion structure 120, a display device 130, a force exertion component 140, a controller 150 and a processor 160. In various embodiments, the flight simulation system 100 includes one or more monitoring devices (e.g., heartbeat sensor, blood pressure sensor, oxidation sensor, ECG, and/or temperature sensor). In various embodiments, the flight simulation system 100 includes system monitoring devices (e.g., motion).

The chair 110 is coupled to the motion structure 120, which is a motorized frame as shown in FIG. 1A. A canopy 165 is coupled to the chair 110, which includes the display device 130 on its interior. The force exertion component 140 is coupled to the chair 110, which is a belting system as shown in FIG. 1A. The controller 150 is coupled to the chair 110. A computer (now shown) is coupled to all of the components of FIG. 1A, directly or indirectly.

During operation, a flight simulation is displayed via the display device 130 to the pilot. The pilot can provide input to the simulation via the controller 150. The input provided by the pilot can be input that causes the simulation to display images to the pilot as if the pilot were flying a plane. The motion structure 120 can move the chair 110 of the pilot to correspond with the input of the pilot to simulate similar movements on the pilot's body to that which the pilot would experience if the pilot was actually flying inside of a plane. For example, if the pilot inputs to maneuver the plane down towards, the motion structure 120 can rotate such that the pilot's face is moved downward towards ground. At the same time, the display device 130 can output an image that corresponds with images that a pilot can see in a downward maneuver, for example, as shown in FIG. 1B. As described above, in some scenarios, dependent upon a pilot's maneuvers, g-force can be imposed upon the body of the pilot. If during the simulation, the pilot inputs a maneuver to the controller 150 which would cause g-force to be felt by the pilot in real life during flight, the force exertion component 140 can exert a force vector onto the pilot such that the pilot can experience a force similar to the g-force on their body. The simulation can be a simulation that corresponds to a type of plane that the pilot is flying. For example, the simulation can be a flight simulator for a F-16.

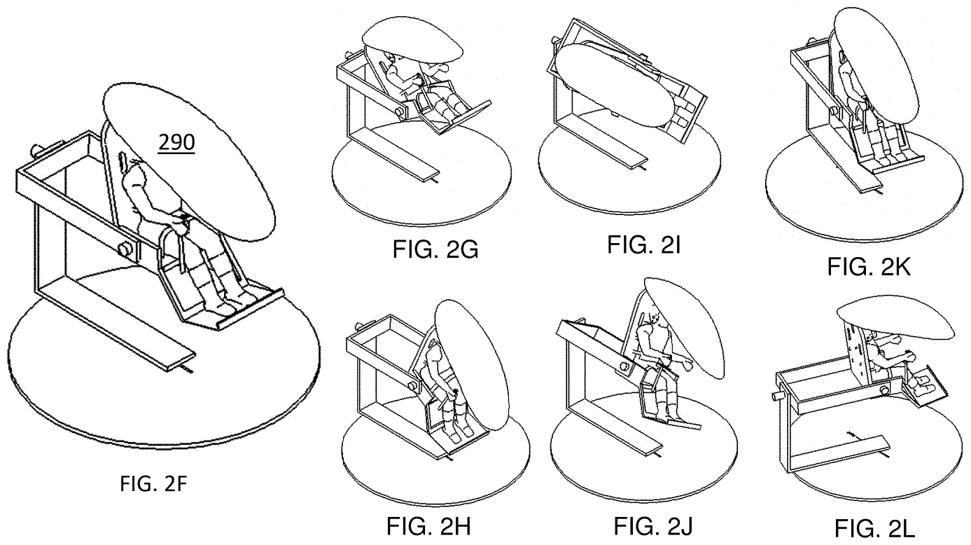

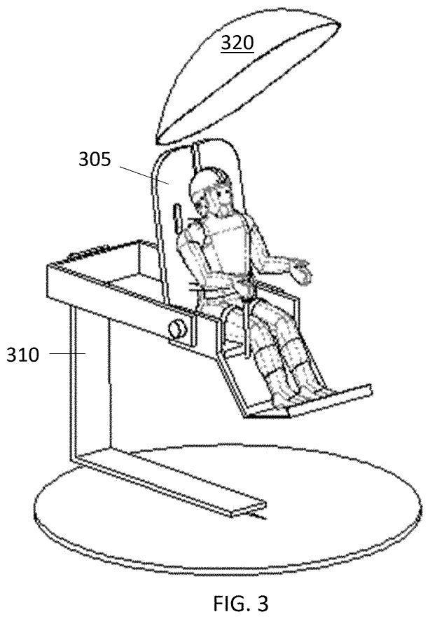

FIGS. 2A-2E are diagrams of a chair 205 and a motion structure 210, according to illustrative embodiments of the invention. The motion structure 210 can have a stationary portion 215 and a moveable portion 220. The stationary portion 215 can be fixed to a base 220. The base 220 can be fixed to ground, on a platform, for example, within an aircraft hanger, within a pilot training school, theme park, or any desired location.

The moveable portion 220 can be coupled to the stationary portion 215. The moveable portion 220 can move with respect to the stationary portion such that it rotates about a first axis 225 (e.g., roll axis) and pivots around a portion of the stationary portion 215 along a second axis 230 (e.g., yaw axis). The coupling between the moveable portion 220 and the stationary portion 215 can be via connector. The connector can be a mechanical coupling. The mechanical coupling can be bearings or rotating sleeves coupled to a driving actuator (motor, cylinder . . . etc.) Compressed air can be fed via air rotating coupling. Electric power can be provided by wired brushes, a wireless coil coupling and/or have a power source on board (e.g., a battery). Data transfer from the controller and data gathered from monitoring devices can be transmitted by wirelessly or through a wired connection (e.g., wired LAN, wireless Bluetooth, Wifi).

The chair 205 can be coupled to the moveable portion 220 such that the chair can rotate about a third axis 235 (e.g., tilt axis relating to the angle of the chair relative to the base). The coupling between the moveable portion 220 and the chair 205 can be via connector(s). The connector(s) can be a rotating mechanism.

The rotating mechanism can be similar for all three axis. There can be a stationary portion which can include a bearing and a driving mechanism as well as compressed air, electric power and/or data coupling devices. In some embodiments, there are no rotating mechanisms.

The moveable portion 220 can have a square c shape, a curved c-shape, a rectangular c-shape. In some embodiments, the stationary portion 215 is L-shaped as shown in FIGS. 2A-2C. In some embodiments, the stationary portion 215 is i-shaped such that there is only one portion standing straight up from the ground. In these embodiments, the bottom of the stationary portion 215 can be inserted into the ground and/or another structure that holds it upright. As is apparent to one of ordinary skill in the art, other structural configurations are possible to hold the stationary portion in place.

The chair 205 can have dimensions such that it can rotate about the third axis. For example, a width of all components the chair 205 can be less than the width between two arms of the moveable portion 220 such that when the chair 205 rotates it does not contact the two arms. In some embodiments, the chair 205 rotates via a 3 axis gimbal mechanism.

The chair 205 can include a force exertion component 207. The force exertion component 207 can be a seat belt. The force exertion component 207 can be tightened and/or loosened to apply a force vector onto a pilot to simulate g-force as is described in further detail below.

The motion structure 210 can be motorized. FIG. 2B shows the structure 210 in a roll position in the clockwise direction. FIG. 2C shows the structure 210 in a roll position in the counter clockwise direction. FIG. 2D shows the structure 210 in a yaw position to the right. FIG. 2E shows the structure 210 in a yaw position to the left.

FIGS. 2F-2L show the structure of FIG. 2A with a canopy 290 and a pilot, according to various embodiments of the invention.

FIG. 2F shows the structure 210 in a neutral position. FIG. 2G shows the structure 210 in a pitched up position. FIG. 2H shows the structure 210 in a pitched down position. FIG. 2I shows the structure 210 in a rolled clockwise position. FIG. 2J shows the structure 210 in a rolled counter clockwise position. FIG. 2K shows the structure 210 in a yaw position to the right. FIG. 2L shows the structure 210 in a yaw position to the left.

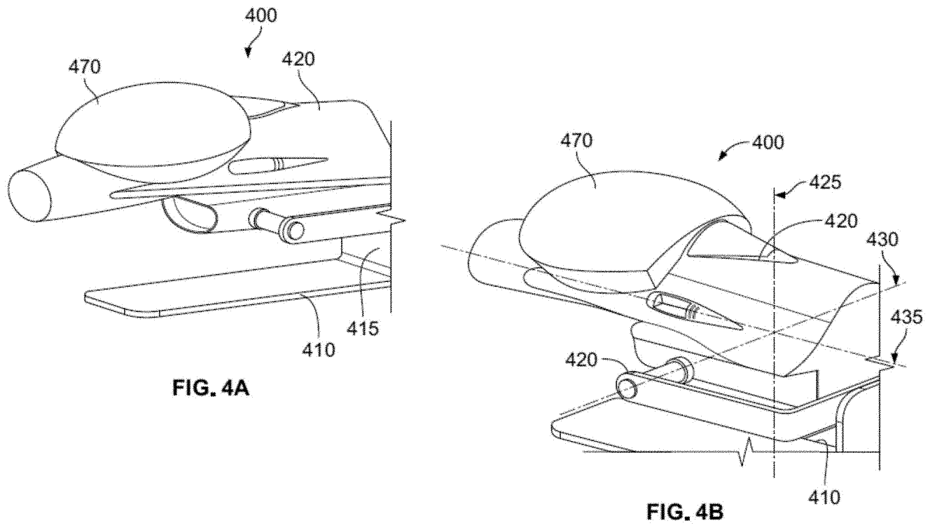

FIG. 3 is a diagram showing a chair 305, a motion structure 310, and a canopy 320, according to an illustrative embodiment of the invention. The chair 305 and the motion structure 310 can be coupled and move as described above with respect to FIG. 2. The canopy 320 can be coupled to the chair 305. The canopy 320 can be coupled to the chair to rotate about an axis that is parallel to the tilt axis. An interior of the canopy 320 can include a display device to display images of the flight simulation to the pilot.

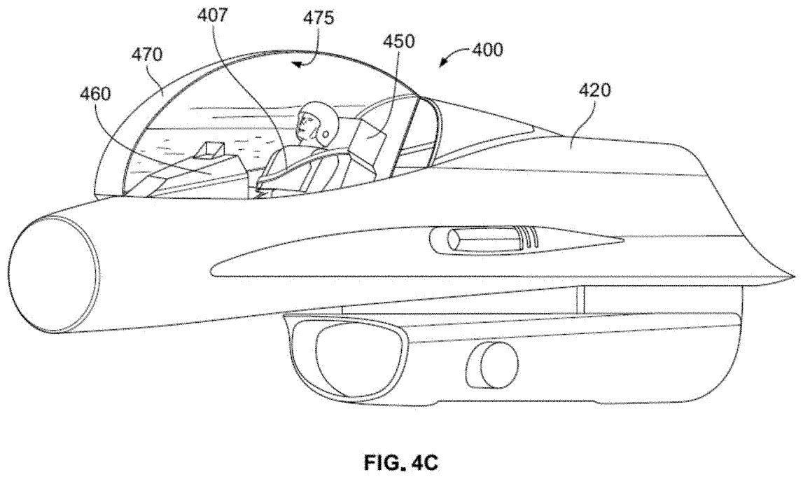

In some embodiments, the canopy 320 can be sized such that when the pilot rotates their head and/or shoulders in the chair the interior of the canopy 320, and thus the display is within line of sight vision and peripheral version of the pilot to, for example, give the pilot realistic view as if the pilot were flying the plane. For example, turning to FIGS. 4A-4C, FIGS. 4A-4C are diagrams of a flight simulator 400, according to illustrative embodiments of the invention.

The flight simulator 400 includes a motion structure 410 and a cockpit structure 420. The motion structure 410 can have a stationary portion 415 and a moveable portion 420. The stationary portion 415 can be fixed to a base 420. The base 420 can be fixed to ground or any desired location.

The moveable portion 420 can connect to the stationary portion 415. The moveable portion 420 can move with respect to the stationary portion such that it rotates about a first axis 425 (e.g., roll axis) and translates along a portion of the stationary portion 415 along a second axis 430 (e.g., pitch axis). The cockpit structure 420 can be coupled to the moveable portion 420 such that cockpit structure 420 can rotate about a third axis 435 (e.g., tilt axis).

The cockpit structure 420 can include a chair 450, a controller 460 and a canopy 470. The chair 450 can include a force exertion component 407. The force exertion component 407 can be a seat belt. The force exertion component 407 can be tightened and/or loosened to apply a force vector onto a pilot to simulate g-force as is described in further detail below.

The canopy 470 can have an interior surface that is a display device 475 as shown in FIG. 4C in a cross-sectional view. The display device on the interior surface of the canopy 470 can be a flexible organic light emitting diode (OLED) screen.

In some embodiments, the display device is a flexible display. In some embodiments, the image is projected on to the interior surface of the canopy, for example, by a projector. In some embodiments, an array of small flat screens is fixed to the interior surface of the canopy and used synchronously as one screen for displaying the simulation. The array can have any number of screens, n, where n is an integer. In some embodiments, the interior surface of the canopy is a multi-array of many small flat displays.

During operation a simulation of a flight can be displayed to the pilot on the display device 475. The position of the eyes of the pilot can be tracked, such that the simulation displayed to the pilot can change based on where the pilot is looking. The displayed image can depend on the canopy shape (e.g., which can be different for different aircrafts), the user's looking direction.

In some embodiments, the system includes one or more sensors that can sense a position of a head of the pilot and/or eyes of the pilot to determine where the pilot is looking. The one or more sensors can transmit it(s) respective sensed information to a computer (e.g., computer 160 as described above in FIG. 1A) to determine an eye and/or head direction of the pilot. The eye and/or head direction can be used by the simulation software that determines the images to display on the display device exactly what images to display. For example, if the pilot is looking straight ahead, the simulation can transmit an image to the display device that a pilot would see if looking straight ahead during the flight. If the pilot looks down, the simulation can transmit an image to the display device that a pilot would see if looking down during the flight. If the pilot turns their head to the right to and looks to the right, the simulation can transmit an image to the display device that a pilot would see if looking right during the flight. In this manner, the simulation can update the display device to transmit a flight simulation that is more realistic then a flight simulation that display a flight image that does not consider the eye and/or head position of the pilot.

The one or more sensors can be one or more video cameras, one or more transmitters coupled to a helmet that the pilot wears, one or more electromagnetic coil positioned coupled to the helmet that the pilot wears, one or more permanent magnet cylinders coupled to the helmet the pilot wears, and/or a gyro coupled to the helmet the pilot wears.

The one or more transmitters coupled to (e.g., positioned on) the helmet can be used with one or more receivers coupled to the canopy and the cockpit to, for example, perform a GPS like triangulation to determine the pilot's eye location and/or looking direction.

The one or more electromagnetic coils and/or permanent magnet cylinders coupled to the helmet can be used with one or more hall probes on the canopy and/or in the cockpit to sense a change of location of the helmet.

The one or more gyro can be based on the motion of the helmet with the motion of the chair (e.g., the cockpit) subtracted out.

The one or more video cameras can capture video of the pilot with hi contrast stickers on the helmet. As the helmet moves, the hi contrast sticker location moves and the location of the pilot's eye/head can be deduced from the moving sticker location.

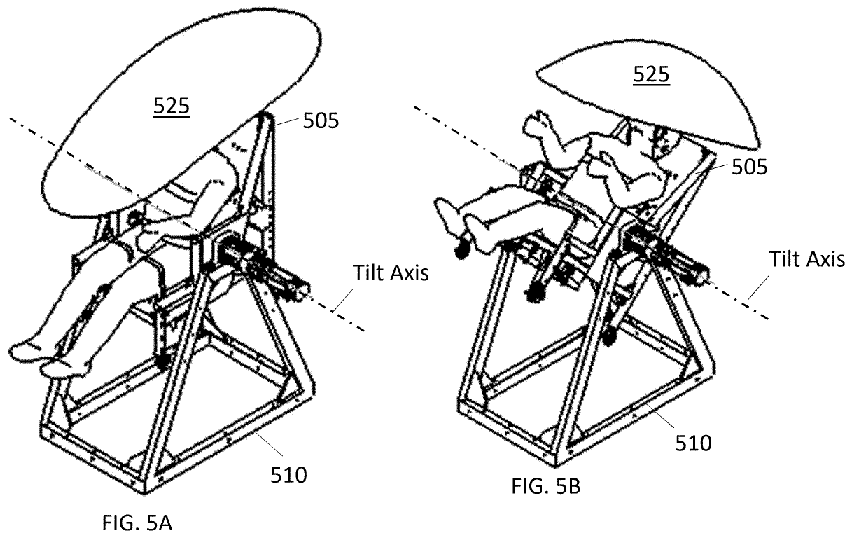

FIGS. 5A and 5B are diagrams of a chair 505, a motion structure 510 and a canopy 525, according to some embodiments of the invention. The chair 505 connects to the motion structure 510 such that the chair rotates about one axis (e.g., tilt axis). The motion structure 510 is stationary.

In various embodiments, the display device is one or a plurality of screens. In some embodiments, the display device is virtual reality googles. In some embodiments, the canopy is not part of the simulation system.

As described above, it can be desired to simulate g-force on the pilot. The g-force can be simulated by one or a plurality of force exertion components. The force exertions components can include components that impose one or more force vectors onto one or more body parts of the pilot. The plurality of force exertions components can apply force vectors with a magnitude and/or direction for a duration that simulates a g-force onto the body of the pilot. The g-force value the system attempts to simulated can vary between a minimum and maximum g-force. The minimum and maximum g-force value can be input by a user, set as a configuration parameter in the flight simulation system or any combination thereof.

The g-force value that the system attempts to simulate during operation (e.g., the desired g-force) can be updated during the simulation based on input from the pilot (e.g., flight maneuvers input by the pilot during the flight simulation), input from the simulation, or any combination thereof.

The one or more force exertion components can impose the plurality of force vectors on the body of the pilot in order to achieve a sensation for the pilot that is similar to the desired g-force.

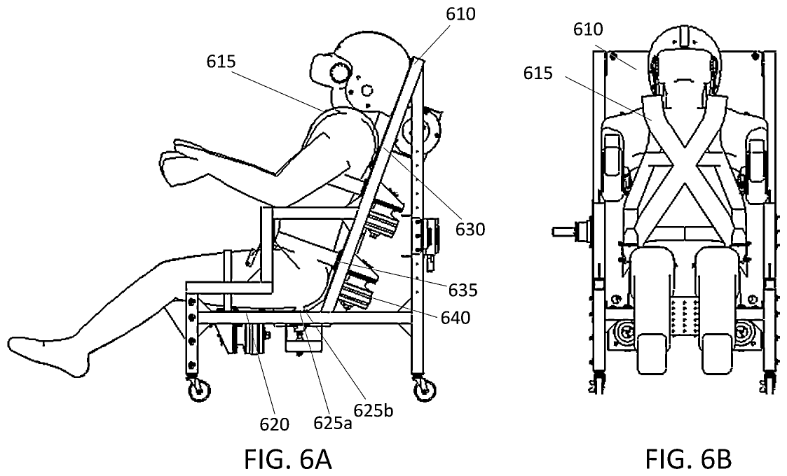

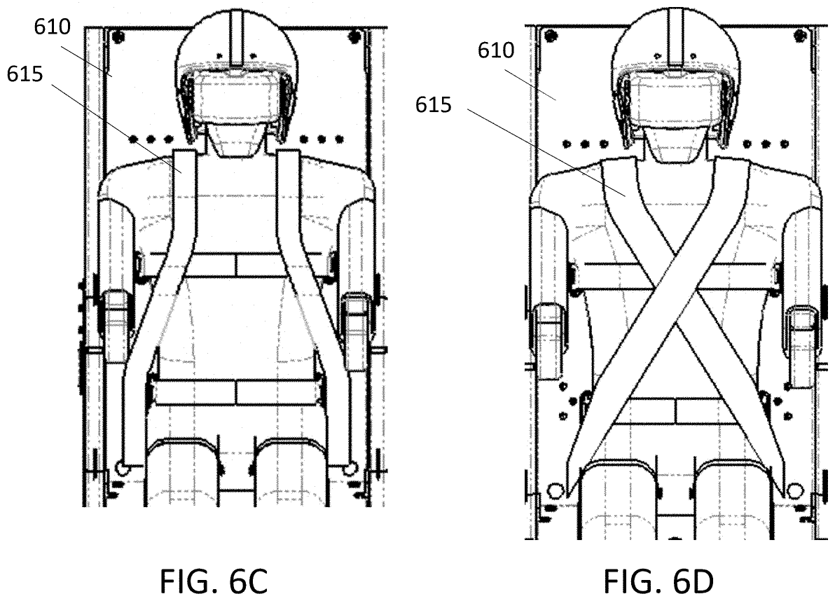

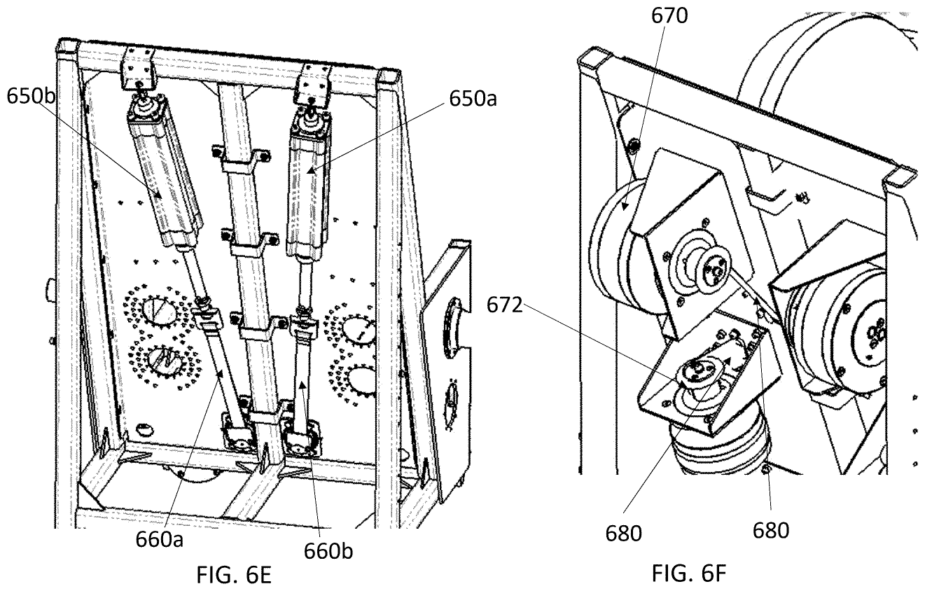

FIGS. 6A and 6B are diagrams of a chair 610 (e.g., chairs as described above) with a force exertion component 615, according to some embodiments of the invention. The force exertion component 615 is coupled to the chair 610. The force exertion component 615 is a belt. The belt 615 can include a first portion that is coupled to a bottom portion, connecting to the chair 610 at points 620, 625a and 625b, and extending along longitudinal axis of the chair 610 to connect to a top end of a back portion of the chair 610 at 630, and a bottom end of the back of the chair 610 at 640. The belt 615 a second belt portion that extends along the longitudinal axis of the chair from the first belt portion to an aperture 635 in a bottom end of the back portion and is coupled to a motor 640 through the aperture 635 such that the motor 640 can tighten and loosen the second belt portion.

During operation, when a pilot sits in the chair and uses the belt, the first portion of the belt goes between the pilots two legs, over each of the pilots two legs, over the chest of the pilot, and over the shoulders of the pilot. The second portion of the belt goes over the shoulders of the pilot down the back of the pilot. The second portion of the belt is tightened or loosened according to the desired g-force to create a force vector that imposes a vertical pressure on the pilot along a spinal column of the pilot. In this manner, when the simulation imposes a g-force on the pilot, the pilot can rotate their torso and head to look “behind” them while experiencing the g-force. This can give the pilot a realistic sensation similar to that which happens during an air combat (e.g., dog fight) between aircraft during which the pilot typically needs to maneuver quickly and look around.

In some embodiments, the first portion of the belt is coupled to a second motor (not show). The second motor can tighten the first portion of the belt to create additional force vectors imposing additional pressure towards the seat onto the body of the pilot.

In various embodiments, the force exertion component of a belt (e.g., the first portion of the belt, the second portion of the belt, or both) can be tightened or loosened (e.g., tensed or released) by a linear mechanism, a rotating mechanism, and/or an expandable cushion. The linear mechanism can directly and/or via transmission pull/release the belt. The linear mechanism can include a pneumatic or hydraulic piston, a linear electric motor (e.g. screw, belt or chain) driven, a piezo linear stage and/or a solenoid. The rotating mechanism can be used with or without a gear and include a pulley/wheel to wind the belt. The rotating mechanism can include an electric motor (e.g., servo or stepper) and/or a pneumatic or hydraulic motor (e.g., vane, piston or gear). The expandable cushion can include a pneumatic and/or hydraulic. A drive system for the linear mechanism, the rotating mechanism, and/or the expandable cushion can be pressure (e.g., pneumatic or hydraulic and/or current to electric drive devices (e.g., devices where higher current can yield higher

FIG. 6C and FIG. 6D are diagrams of the chair 610 and the force exertion component 615 in two different configurations, straight and crisscross, on the pilot, according to some embodiments of the invention.

FIG. 6E and FIG. 6F are diagrams of tensing units (e.g., belt driving mechanisms), according to some embodiments of the invention. FIG. 6E is a diagram a linear mechanism implemented as pneumatic pistons 650a and 650b coupled to belts 660a and 660b. During operation, the pneumatic pistons, 650 can tighten or loosen the belts 660, according to a desired g-force to simulate. FIG. 6F is a diagram of a rotating mechanism implemented as a pneumatic rotating motor 670 and pulley 672 coupled to the belt 680. During operation, the pneumatic rotating motor 670 causes the pulley 672 to rotate to cause the belt 680 to tighten or loosen, according to a desired g-force to simulate.

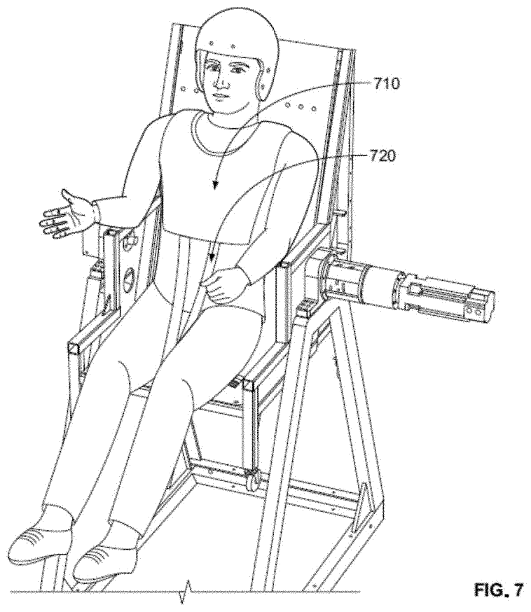

In some embodiments, the force exertion component is a vest. Turning to FIG. 7, FIG. 7 is an example of a force exertion component of a vest 710 coupled to a belt 720, according to some embodiments of the invention. The vest 710 can be inflated such that a force vector is imposed on a chest of the pilot. This can cause the pilot's lungs to feel pressure and strain breathing. The belt 720 can be tightened similar to as described above in FIGS. 6A and 6B, such that a force vector can impose vertical pressure on the spinal column of the pilot.

In various embodiments, the belts can be controlled via an open and/or closed control loop. In an open loop control, based on the desired g, the required force and/or the required pressure or electric current to be applied on the motor/piston can be determined in order to get the required force. The required force can be determined based on one or more of the pulley effective diameter, belts lay out, piston diameter, friction, gear ration and efficiency (e.g., if gear or any transmission mechanism is used). In a closed loop control, based on the desired g, the actual force applied on the belt can be measured and compared to desired value. For example, a strain gauge can be used to provide force feed back (e.g., real-time). In some embodiments, the tension on the belts can change during the simulation by the movement of the pilot (e.g., the pilot turning her torso to see behind her). In these embodiments, the closed loop control can sense the tension change and adjust the tension applied to the belt based on the tension change.

The force to be applied to the pilot during the simulation can be determined by multiplying the acceleration of the plane in the simulation by the mass of the pilot. The force can be applied adjusting the tension of the belts. For example, assume that the desired force to apply to the pilot is 200 Newton on the pilot's leg. A pressure in a cylinder can be applied to cause the 200 Newton force to be applied to the pilot's leg. In some scenarios, errors (e.g., friction) can cause the actual applied force to be less or greater than the desired force, such that the strain gauge can measure the actual applied force. When this actual measured applied force is compared to desired force, the controller can cause a further tightening or loosening to add or subtract pressure to reach the desired force.

In some embodiments, the desired force is modified based on a skill level of the pilot. For example, for an unskilled pilot the desired force can be reduced. For an experienced pilot, it can be increased.

In some embodiments, the desired force is multiplied by a weighting factor. In various embodiments, each of the belts has its own actuator and the force of each belt is controlled independently. In various embodiments, the amount of pressure is spread across the pilots body. For example, a first percentage can be applied to the legs, a second percentage can be applied to the shoulders, and a third percentage can be applied to the diaphragm.

In some embodiments, the g-force applied is displayed to the pilot.

In some embodiments, the system includes a release button. The release button when depressed can cause the tension in the belts to release completely irrespective of the simulation posture. In this manner, a pilot can have complete control over whether to continue with the simulation or not.

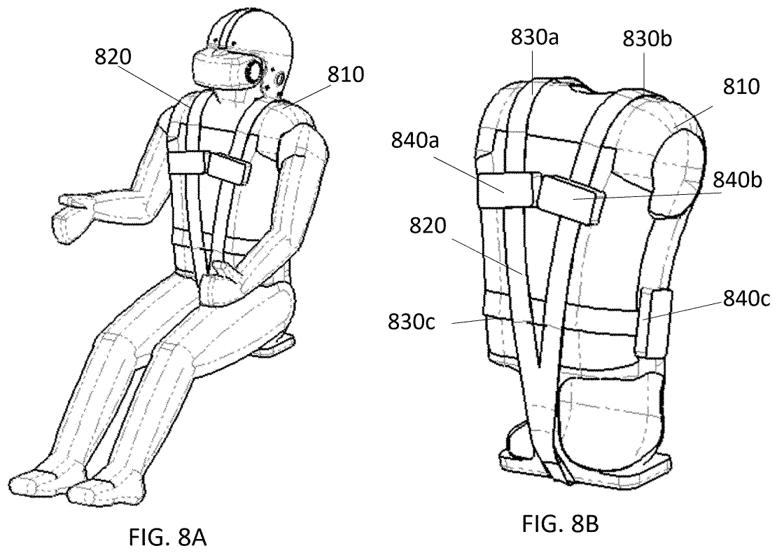

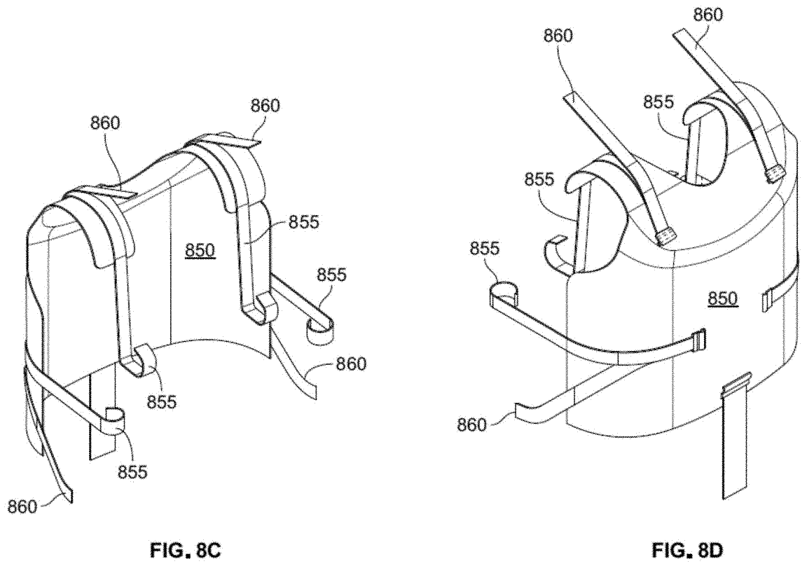

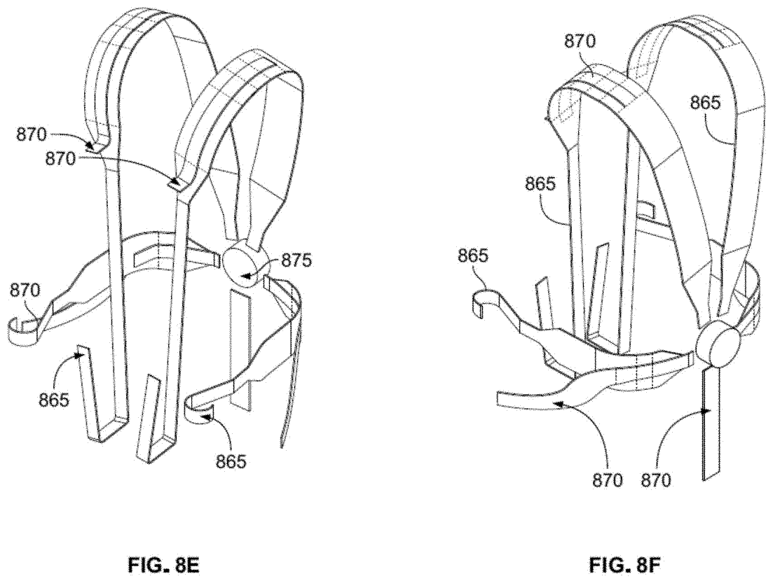

In some embodiments, the force exertion components are not coupled to the chair. For example, turning to FIGS. 8A and 8B, FIGS. 8A and 8B are an example of a force exertion component of a jacket 810 coupled to a belt 820, according to some embodiments of the invention. The belt 820 can include a first portion having two straps 830a and 830b that extends longitudinally along the jacket and over the shoulders of the jacket. Each belt strap 830a and 830b can be coupled to its own belt tensing unit 840a and 840b, respectively. The belt can have a second portion having one strap 830c that extends perpendicular to the two straps 830a and 830b transverse the jacket and can be coupled to its own belt tensing unit 840c. Each of the belt tensing units 840a, 840b, and/or 840c can include a motor, solenoid, pneumatic piston and/or hydraulic piston. Each of the belt tensing units 840a, 840b, and/or 840c can also include a rechargeable power source, strain gauge (e.g., to monitor force vectors applied), and/or a communication unit (wired or non-wired) to communicate information regarding the force applied to, for example the processor of the simulation.

Turning to FIGS. 8C and 8D, FIGS. 8C and 8D are an example of a force exertion component of a vest 850 having multiple belts 855 that connect to an airplane and multiple belts 860 that are coupled to a respective belt tensing unit (e.g., belt tensing unit 840a as discussed above in FIGS. 8A and 8B), according to embodiments of the invention.

FIGS. 8E and 8F are an example of force exertion component of multiple belts 865 that connect to an airplane and multiple belts 870 that are coupled to a respective belt tensing unit (e.g., belt tensing unit 840a as discussed above in FIGS. 8A and 8B), according to embodiments of the invention. The multiple belts 865 and multiple belts 870 can be coupled to a quick release camlock 875.

In some embodiments, the belts are in a crisscross configuration such that they form an X shape across the chest of the pilot. In these embodiments, the pilot can rotate to “look” behind the seat, and the g-force can continue being applied.

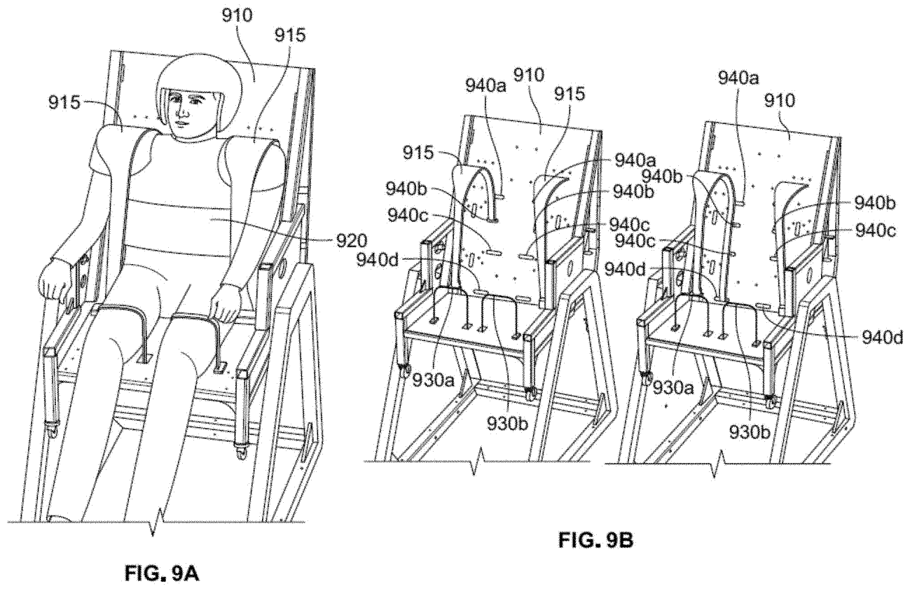

In some embodiments, the seat includes a plurality of apertures so that a direction of the force vector created by the belt over the shoulders can be modified. For example, turning to FIGS. 9A and 9B, FIGS. 9A and 9B are an example of a plurality of force exertion components and a seat 910, according to some embodiments of the invention. The plurality of force exertion components include a first belt 915, a second belt 920, and leg clamping components 930a and 930b. The seat 910 includes a plurality of apertures, generally 940, to pass the first belt 915 through. Passing the first belt through the apertures at the top of the seat 940a, can provide a pilot with the least amount of freedom to rotate their torso when a force is applied, with increasing freedom as the first belt 915 is passed through the apertures down the back of the seat. The first belt 915 can impose a force vector of spinal pressure onto the pilot. The second belt 920 can impose a force vector of stomach and lung pressure onto the pilot. The leg claiming mechanisms can apply force vectors of thigh pressure onto the pilot.

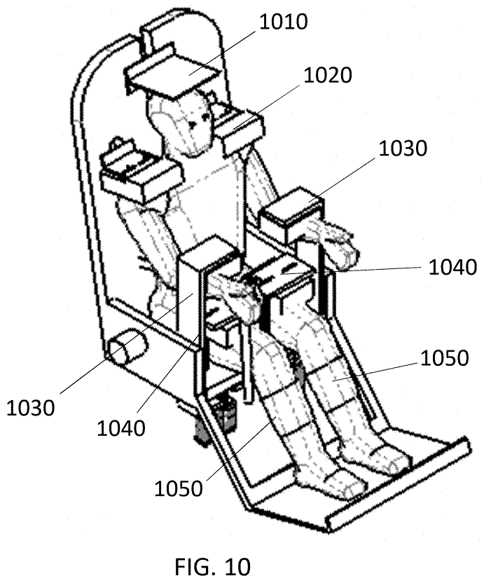

In some embodiments, there are a plurality of force exertion components. For example, turning to FIG. 10. FIG. 10 shows an example of a plurality of force exertion components, according to some embodiments of the invention. The plurality of force exertion components include a head pressure plate 1010, shoulder pressure plates 1020, wrist pressure plates 1030, leg pressure plates 1040, and calf pain simulators 1050. Each of the plurality of force exertion components can include apply force vectors to the body of the pilot to simulate g-force.

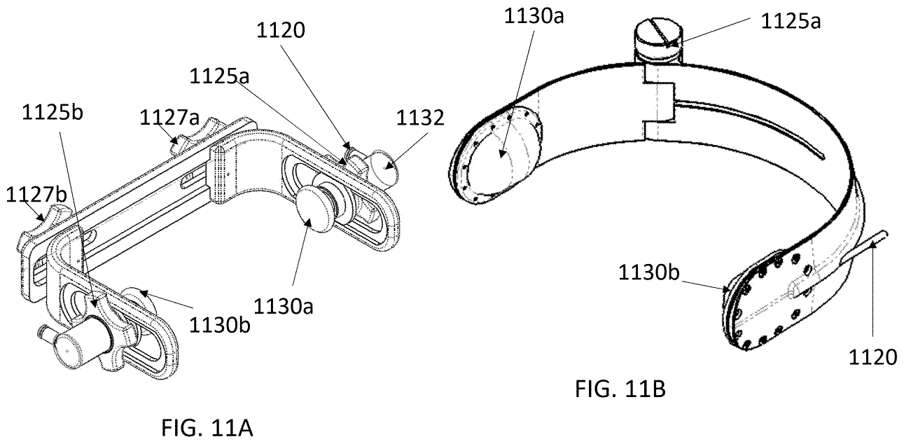

In some embodiments, blood flow to the brain of the pilot can be restricted to simulate the effect of g-force. For example, turning to FIGS. 11A and 11B, FIGS. 11A and 11B show a force exertion component of an artery claiming mechanism, according to some embodiments of the invention. The artery clamping mechanism 1110 is a neck brace that couples to a neck of the pilot. The neck brace 1110 includes pressure components that can apply force vectors towards the neck of the pilot. If positioned abutting an artery of the pilot, the pressure components can apply a force vector such that some blood flow can be limited via restricting blood flowing via the artery of the pilot. As shown in both FIGS. 11A and 11B, there can be an air flow inlet 1120, control valves 1125a and 1125b, that inflates and/or deflates pads 1130a and 1130b that can be in contact with the pilot. The neck brace can also include size control knobs 1127a and 1127b and piston 1132. In some embodiments, as shown in FIG. 11A, the neck brace 1110 is adjustable, such that the pads 1130a, 1130b can be situated in a particular location so that the neck brace 1110 can fit pilots with different sized necks. In some embodiments, the pads 1130a and 1130b are an air cushion, as shown in FIG. 11B.

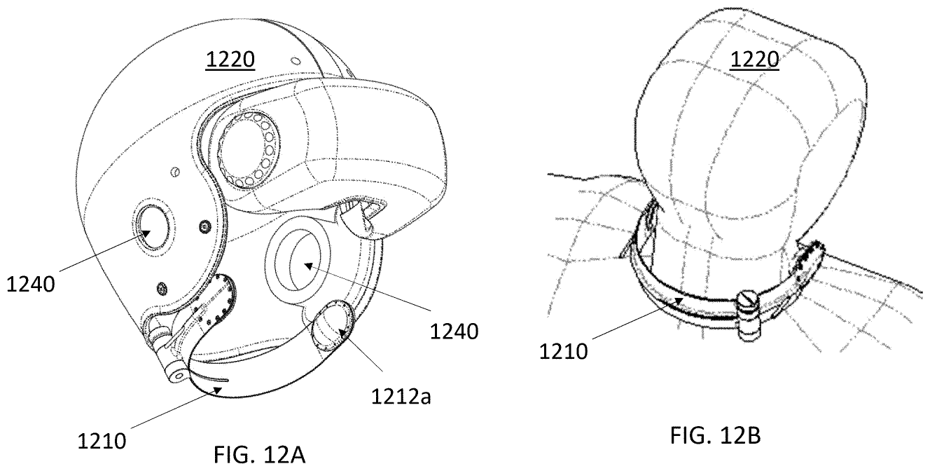

In some embodiments, the artery clamping mechanism is a clamp coupled to a helmet. Turning to FIGS. 12A and 12B, FIGS. 12A and 12B are diagrams showing an artery claiming mechanism 1210 coupled to a helmet 1220, according to some embodiments of the invention. The artery clamping mechanism 1210 can be a clamp having pneumatic controlled cushions 1212a and 1212b that can connect to an artery of the pilot when the helmet 1220 is put on. When the air cylinder 1222 (e.g., piston driven by compressed air) is activated, the clamp closes to restrict the blood flow of the arteries of the pilot. The helmet 1220 can also include a force exertion component of an ear pressure device 1240 that applies a force vector of pressure to the ears, similar to the pressure a pilot experiences during flight. In some embodiments, the ear pressure device can also include audio output (e.g., to output audio of the simulation and/or audio of an instructor).

In some embodiments, the helmet includes a mechanism to close a nose of the pilot.

In some embodiments, the helmet includes an air breathing mask as described above.

In various embodiments, there are a plurality of force exertion components. In various embodiments, any combination of the force exertion components described above can be used in the simulation.

In various embodiments, the flight simulator as described above and/or a subset of the components can be used in an amusement park, as a home gaming system, in museums, or any scenario where simulating flight is desired. In these scenarios, g-force simulated can be reduced such that the force vectors have a magnitude less then what is typically experienced in real life.

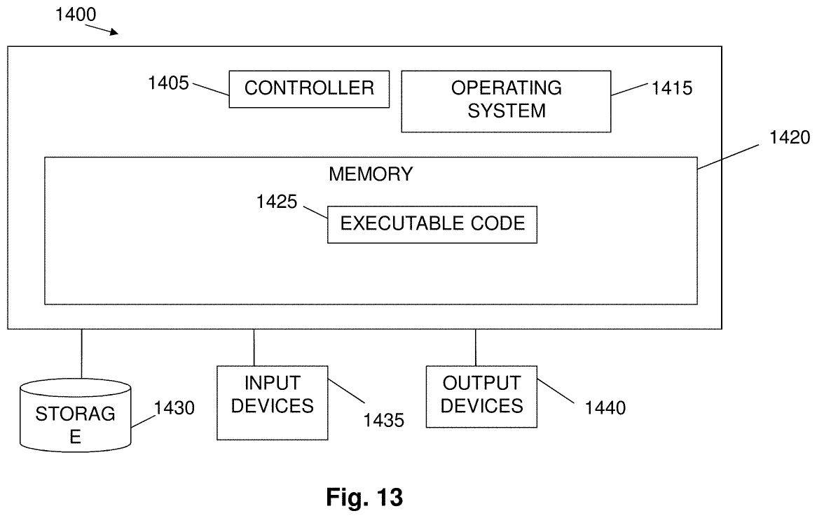

FIG. 13 shows a block diagram of a computing device 1400 which can be used with embodiments of the invention. Computing device 1400 can include a controller or processor 1405 that can be or include, for example, one or more central processing unit processor(s) (CPU), one or more Graphics Processing Unit(s) (GPU or GPGPU), FPGAs, ASICs, combination of processors, video processing units, a chip or any suitable computing or computational device, an operating system 1415, a memory 1420, a storage 1430, input devices 1435 and output devices 1440.

Operating system 1415 can be or can include any code segment designed and/or configured to perform tasks involving coordination, scheduling, arbitration, supervising, controlling or otherwise managing operation of computing device 1400, for example, scheduling execution of programs. Memory 1420 can be or can include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 1420 can be or can include a plurality of, possibly different memory units. Memory 1420 can store for example, instructions to carry out a method (e.g. code 1425), and/or data such as user responses, interruptions, etc.

Executable code 1425 can be any executable code, e.g., an application, a program, a process, task or script. Executable code 1425 can be executed by controller 1405 possibly under control of operating system 1415. For example, executable code 1425 can when executed cause masking of personally identifiable information (PII), according to embodiments of the invention. In some embodiments, more than one computing device 1400 or components of device 1400 can be used for multiple functions described herein. For the various modules and functions described herein, one or more computing devices 1400 or components of computing device 1400 can be used. Devices that include components similar or different to those included in computing device 1400 can be used, and can be connected to a network and used as a system. One or more processor(s) 1405 can be configured to carry out embodiments of the invention by for example executing software or code. Storage 1430 can be or can include, for example, a hard disk drive, a floppy disk drive, a Compact Disk (CD) drive, a CD-Recordable (CD-R) drive, a universal serial bus (USB) device or other suitable removable and/or fixed storage unit. Data such as instructions, code, NN model data, parameters, etc. can be stored in a storage 1430 and can be loaded from storage 1430 into a memory 1420 where it can be processed by controller 1405. In some embodiments, some of the components shown in FIG. 10 can be omitted.

Input devices 1435 can be or can include for example a mouse, a keyboard, a touch screen or pad or any suitable input device. It will be recognized that any suitable number of input devices can be operatively connected to computing device 1400 as shown by block 1435. Output devices 1440 can include one or more displays, speakers and/or any other suitable output devices. It will be recognized that any suitable number of output devices can be operatively connected to computing device 1400 as shown by block 1440. Any applicable input/output (I/O) devices can be connected to computing device 1400, for example, a wired or wireless network interface card (NIC), a modem, printer or facsimile machine, a universal serial bus (USB) device or external hard drive can be included in input devices 1435 and/or output devices 1440.

Embodiments of the invention can include one or more article(s) (e.g. memory 1420 or storage 1430) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

One skilled in the art will realize the invention can be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

Although embodiments of the invention are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

Although embodiments of the invention are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

1. A system for simulating flight and corresponding G-force for a pilot, the system comprising:
a seating area including a plurality of force exertion components coupled to the seating area to apply a plurality of force vectors to a plurality of body parts of the pilot; and
a processor in communication with the plurality of force exertion components to control the plurality of force exertion components to apply the plurality of force vectors to the plurality of body parts, wherein an amplitude, direction and duration of the plurality of force vectors applied to the body parts are based on an amount of G-force to simulate on the body of the pilot according to a simulation of a flight.

2. The system of claim 1 wherein the system further comprises:
a motorized frame coupled to the seating area to rotate the seating area along a pitch axis, yaw axis, roll axis, or any combination thereof; and
wherein the processor is further in communication with the motorized frame to cause the motorized frame to rotate the seating area based on input from the pilot and the simulation of the flight, and

3. The system of claim 1 wherein the plurality of force exertion component includes:
a jacket:
two belts that span along a longitudinal axis of the jacket coupled to at least one tensing unit; and
a third belt that is positioned perpendicular to the two belts and is coupled to the at least one tensing unit, wherein the at least one tensing unit tightens and loosens the two belts and the third belt to cause at least one of the plurality of force vectors.

4. The system of claim 1 wherein the plurality of force exertion component includes:
a jacket:
two belts that span along a longitudinal axis of the jacket coupled to a respective tensing unit; and
a third belt that is positioned perpendicular to the two belts and is coupled to a respective tensing unit, wherein each respective tensing unit and loosens the two belts and the third belt to cause at least one of the plurality of force vectors.

5. The system of claim 1 wherein the plurality of force exertion components includes a harness comprising:
a first belt portion that is coupled to a bottom portion of the seating area extends along a longitudinal axis of the seating area and is coupled to a top end of a back portion of the seating area; and
a second belt portion that extends along the longitudinal axis of the seating area from the first belt portion to an aperture in a bottom end of the back portion and is coupled to a motor through the aperture such that the motor can tighten and loosen the second belt portion to cause at least one of the plurality of force vectors along the longitudinal axis.

6. The system of claim 1 further comprising an artery clamping mechanism for applying a second force vector to an artery of the pilot to restrict blood flow into the head of the pilot to further simulate G-force on the body of the pilot.

7. The system of claim 4 wherein the artery clamping mechanism is a c-shaped structure.

8. The system of claim 4 wherein the artery clamping mechanism is a neck brace that includes one or more pads that inflate or deflate.

9. The system of claim 4 wherein the artery claiming mechanism is a neck brace that includes a controlled spring mechanism.

10. The system of claim 1 further comprising one or more sensors to detect an eye location of the pilot's eye.

11. The system of claim 1 further comprising one or more sensors to detect a looking direction of the pilot.

12. The system of claim 1 further wherein the plurality of force exertion components are belts and each belt is coupled to a pneumatic piston, a hydraulic piston, a pneumatic motor, a hydraulic motor or an electric rotating motor.

13. The system of claim 1 wherein the seating area is housed within a structure that appear similar to a cockpit of a aircraft of the simulation.

14. The system of claim 1 wherein the plurality of force exertion components are positioned to apply force on legs, shoulders, wrists, head, chest, neck or any combination thereof of the pilot.

15. The system of claim 1 wherein the plurality of force exertion components apply a force to the pilot dependent upon an acceleration of the airplane in the simulation and a mass of the pilot.

16. The system of claim 1 wherein the plurality of force exertion components apply a force to the pilot dependent upon an input of the pilot.

17. A system for simulating flight and corresponding G-force for a pilot, the system comprising:
a motorized frame coupled to a seating area to rotate the seating area along a pitch axis, yaw axis, roll axis, or any combination thereof;
a processor in communication with the motorized frame to control the motorized frame to rotate the seating area based on input from the pilot and a simulation of the flight, and

18. A system for simulating flight and corresponding G-force for a pilot, the system comprising:
a canopy coupled to a seating area to rotate over the seating area, the canopy having an interior surface that includes an OLED display device to display a simulation of a flight;
a processor in communication with OLED display device to control the OLED display device output based on input from the pilot and the simulation of the flight.

19. The system of claim 1 further comprising an artery clamping mechanism for applying a second force vector to an artery of the pilot to restrict blood flow into the head of the pilot to further simulate G-force on the body of the pilot.

20. The system of claim 1 further comprising one or more sensors to detect an eye location of the pilot's eye.

21. The system of claim 18 further comprising an artery clamping mechanism for applying a second force vector to an artery of the pilot to restrict blood flow into the head of the pilot to further simulate G-force on the body of the pilot.

22. The system of claim 21 wherein the artery clamping mechanism is a c-shaped structure.

23. The system of claim 21 wherein the artery clamping mechanism is a neck brace that includes one or more pads that inflate or deflate.

24. The system of claim 21 wherein the artery claiming mechanism is a neck brace that includes a controlled spring mechanism.

25. The system of claim 18 further comprising one or more sensors to detect an eye location of the pilot's eye.

26. The system of claim 18 further comprising one or more sensors to detect a looking direction of the pilot.

27. The system of claim 18 further comprising:
a seating area including a plurality of force exertion components coupled to the seating area to apply a plurality of force vectors to a plurality of body parts of the pilot; and
a motorized frame coupled to the seating area to rotate the seating area along a pitch axis, yaw axis, roll axis, or any combination thereof;
wherein the processor is in further communication the motorized frame and the plurality of force exertion components to control:
i) the plurality of force exertion components to apply the plurality of force vectors to the plurality of body parts, wherein an amplitude, direction and duration of the plurality of force vectors applied to the body parts are based on an amount of G-force to simulate on the body of the pilot, and
ii) the motorized frame to rotate the seating area based on input from the pilot and the simulation of the flight.

28. The system of claim 27 wherein the plurality of force exertion components are positioned to apply force on legs, shoulders, wrists, head, chest, neck or any combination thereof of the pilot.

29. The system of claim 27 wherein the plurality of force exertion components apply a force to the pilot dependent upon an acceleration of the airplane in the simulation and a mass of the pilot.

30. The system of claim 27 wherein the plurality of force exertion components apply a force to the pilot dependent upon an input of the pilot.
